(19) United States
(12) Patent Application Publication
(10) Pub. No.: US 2026/0278331 A1
(43) Pub. Date: Sep. 17, 2026

(54) MODIFIED MECHANICAL SPECIFIC ENERGY SYSTEM AND METHODS USING A TERNARY GRAPH-BASED APPROACH

(71) Applicant: Ian Allahar, Katy, TX (US)

(72) Inventor: Ian Allahar, Katy, TX (US)

(73) Assignee: Wellbore Consultants LLC, Katy, TX (US)

(21) Appl. No.: 19/080,840

(22) Filed: Mar. 15, 2025

(51) Int. Cl. G06N 3/042; E21B 45/00; E21B 47/007; E21B 49/00; G06N 3/092

(52) U.S. Cl. CPC G06N 3/042; E21B 45/00; E21B 47/007; E21B 49/005; G06N 3/092; E21B 2200/20; E21B 2200/22

(57) ABSTRACT

The Modified Mechanical Specific Energy (MSE 3.0) system introduces an advanced, AI-driven drilling optimization approach. Unlike traditional models, MSE 3.0 integrates a ternary graph-based visualization to dynamically analyze cuttings morphology, pipe vibration, and MSE in real time. The system utilizes machine learning algorithms for predictive analytics, second-order optimization for early inefficiency detection, and a cost-effective surface-based measurement approach. By eliminating reliance on downhole sensors, MSE 3.0 reduces operational costs while enhancing drilling efficiency, making it applicable to hydrocarbon, geothermal, and critical mineral extraction operations. A key innovation of MSE 3.0 is the integration of real-time Cuttings Morphology Analysis, providing a direct, continuous assessment of downhole conditions and formation response. This enables precise, data-driven optimization of drilling patterns, significantly improving predictive accuracy and wellbore stability over conventional single-variable MSE models.

### BACKGROUND

### Field of the Invention

Embodiments disclosed herein relate generally to a Modified Mechanical Specific Energy System apparatus and methods referred to as MSE 3.0, used to optimize operation parameters used while drilling wellbores utilized for, but not limited to, the production of hydrocarbons.

More specifically, the present disclosure pertains to a ternary graph-based optimization model, that incorporates real-time Cuttings Morphology Analysis, Drill Pipe Vibration Analysis and real-time Drilling Parameters Analysis to provide real-time Modified MSE values, allowing operators to make data-driven adjustments to optimize drilling performance.

Additionally, a second-order optimization model is used to predict inefficiencies before they occur, enabling automated parameter adjustments.

The MSE 3.0 system refines drilling efficiency by comparing real-time drill pipe vibration with historical sweet spot data and making preemptive parameter recommendations to reduce instability. By combining real-time monitoring, AI-based learning, and predictive analytics, this system significantly enhances drilling efficiency, reduces unnecessary energy consumption, extends bit life, and improves overall wellbore stability.

The present disclosure introduced here can be applied to all areas where wellbore construction is required; such as, but not limited to, hydrocarbon production, energy production from geothermal well, carbon capture and storage operations, mineral extraction in critical elements mining operations.

### Background Art

Optimizing drilling efficiency is critical for economic success in oil, gas, and geothermal energy extraction. Mechanical Specific Energy (MSE) has been widely used to measure energy efficiency in drilling by evaluating the energy required to destroy a given volume of rock. However, existing MSE-based methods suffer from inherent limitations: they rely on first-order calculations, making them reactive rather than predictive, and depend heavily on costly downhole sensors that degrade in harsh drilling conditions.

Several prior systems have attempted to optimize drilling efficiency through MSE-based analysis. For example, U.S. Pat. No. 8,833,487 B 2(2014) describes a downhole drilling assembly equipped with sensors to measure parameters such as torque, weight on bit, and revolutions per minute, enabling real-time calculation of instantaneous MSE to adjust drilling parameters and maximize the rate of penetration (ROP).

Similarly, U.S. Pat. No. 9,920,614 B 2(2018) presents a method for drilling wellbores by utilizing bit-based weight and torque sensors to determine MSE, facilitating the adjustment of drilling parameters to enhance efficiency.

Additionally, U.S. Pat. No. 11,773,712 B 2(2021) introduces a method for optimizing borehole drilling by measuring parameters related to axial and torsional motion of the drill string, determining axial force and torque applied to the drill bit, and adjusting these parameters to align the mechanical specific energy applied to the formation with its estimated confined compressive strength.

Furthermore, US Patent Application 2008/0156531 A1 (Nabors Global Holdings Ltd., 2008) discloses automated MSE-based drilling apparatus and methods, focusing on detecting MSE parameters and utilizing them to optimize drilling operations.

Moreover, US Patent Application 2010/0252325 A1 (National Oilwell Varco, 2010) details methods for determining mechanical specific energy for wellbore operations by measuring power input to machines used in drilling operations and calculating MSE to optimize drilling performance.

However, all prior approaches rely exclusively on first-order MSE changes, meaning they only respond to performance inefficiencies after they have already occurred. This reactionary approach assumes that real-time adjustments are fast enough to prevent drilling inefficiencies, but in practice, delays in recognizing instability lead to increased energy consumption, tool damage, and inefficient drilling operations.

Unlike prior models, which only react to inefficiencies after they occur, MSE 3.0 introduces a second-order derivative approach that identifies instability before it impacts drilling performance. Instead of waiting for MSE fluctuations to indicate dysfunction, MSE 3.0 detects accelerating changes in MSE trends, allowing for preemptive adjustments. This innovation directly contradicts prior industry assumptions that monitoring instantaneous MSE values is sufficient

This unexpected advantage directly contradicts traditional drilling optimization models, which assume that monitoring instantaneous MSE values is sufficient. In contrast, MSE 3.0's predictive analytics provide a real-time early warning system, allowing operators to prevent inefficiencies before they impact drilling performance.

For example, in conventional drilling models, stick-slip vibration is only recognized after torque fluctuations reach critical levels. Using the second-derivative MSE model, MSE 3.0 detects instability earlier, enabling preemptive parameter adjustments that reduce drilling dysfunctions and prolong bit life,

Prior MSE models required operators to manually interpret inefficiencies and adjust drilling parameters accordingly. This approach delayed corrective actions, as human decisions are slower and prone to inconsistency. In contrast, MSE 3.0 integrates AI-driven real-time optimization, autonomously adjusting Weight on Bit (WOB), Rotational Speed (RPM), and Torque on Bit (TOB) based on continuously updated multi-variable inputs

By integrating all three variables into a ternary model, the present invention achieves faster inefficiency detection and correction. The ternary graph does not simply overlay data; rather, it computes interdependencies that would otherwise remain hidden in traditional single-variable analysis. This unexpected advantage enables operators to proactively adjust parameters before instability occurs, significantly improving drilling efficiency.

For example, in conventional drilling optimization, vibration data and cuttings analysis are often reviewed separately, meaning that a deteriorating bit condition might be recognized only after significant performance loss. With the ternary model, cross-correlation between MSE changes, vibration anomalies, and cuttings texture provides an earlier warning system, preventing failure before it escalates.

Thus, there is a clear industry demand for an advanced monitoring and optimization system that can integrate real-time drilling data, specifically incorporating cutting morphology analysis, drill pipe vibration monitoring, and standard MSE data to dynamically refine drilling operations. The capability to analyze these factors concurrently and proactively modify drilling parameters can significantly enhance drilling efficiency, stability, and cost-effectiveness.

### Field of Invention

The invention described herein addresses these challenges by introducing a novel system, the Modified Mechanical Specific Energy (MSE 3.0). This system employs a ternary graph-based optimization approach, integrating three essential real-time factors.

Cuttings Morphology Analysis: Leveraging computer vision and AI to continuously analyze cuttings size, shape, and texture in real time, providing immediate insights into bit performance and formation response.

Drill Pipe Vibration Analysis: Utilizing advanced acoustic and accelerometer-based sensors to monitor axial, torsional, and lateral vibrations of the drill string, enabling early detection of drilling dysfunctions.

Drilling Parameters Analysis: Continuously determining optimal drilling parameter values to ensure efficient drilling and optimal hole cleaning.

Through real-time analysis and correlation of these parameters, the system dynamically calculates the Modified MSE, delivering precise, actionable insights that help drillers adjust operational parameters proactively. Additionally, the system incorporates historical “sweet spot” drilling data to refine predictive analytics, further enhancing its adaptive capacity.

Moreover, the system employs a second-order optimization model that evaluates the rate of change of the Modified MSE, comparing real-time vibration data with historical baseline “sweet spot” data to detect early signs of drilling inefficiencies. This capability enables proactive adjustments to drilling parameters, significantly enhancing operational stability and reducing the risk of costly downtime.

By integrating real-time monitoring, advanced analytics, and adaptive machine learning, the Modified MSE 3.0 system represents a significant advancement in drilling technology, offering substantial improvements in drilling efficiency, energy management, bit longevity, and overall wellbore stability.

While previous patents, such as U.S. Pat. Nos. 8,833,487 B2, 9,920,614 B2, 11,773,712 B2, 2008/0156531 A1, and US 2010/0252325 A1, focus on downhole-based MSE measurements, real-time drilling parameter adjustments, and automated optimization techniques, they each have key limitations.

Most notably, prior systems rely heavily on downhole sensor data, making them costly to implement and maintain. Additionally, these approaches typically analyze MSE as a single-variable metric, failing to integrate cuttings morphology, pipe vibration, and real-time machine learning-driven parameter optimization into a single predictive model.

A long-standing industry assumption is that the more downhole sensors a system uses, the more accurate its measurements will be. However, MSE 3.0 contradicts this belief by demonstrating that eliminating downhole sensors in favor of AI-driven data reconstruction provides greater accuracy.

Unlike conventional models that require costly downhole sensors prone to mechanical degradation, MSE 3.0 eliminates this dependency by using AI-driven surface-based modeling. This approach reconstructs downhole conditions with equal or greater accuracy, leveraging historical drilling data, real-time surface telemetry, and machine learning to infer Weight on Bit (WOB), Torque on Bit (TOB), and drilling vibrations—without requiring direct downhole instrumentation.

The Modified MSE 3.0 System overcomes these challenges by:

Introducing a ternary graph-based optimization model, which provides a multi-dimensional real-time visualization of drilling conditions, unlike prior systems that use isolated parameter analysis.

Eliminating the need for costly downhole sensors by utilizing a surface-based measurement approach, significantly reducing operational costs while maintaining drilling optimization accuracy.

Leveraging machine learning for predictive analytics, dynamically adjusting drilling parameters in real time based on historical and real-time data.

Implementing second-derivative MSE calculations, allowing for preemptive inefficiency detection, which prior models do not account for.

MSE 3.0 represents the first system to combine second-derivative MSE calculations, ternary graph-based inefficiency detection, and AI-driven real-time parameter optimization into a cost-effective, surface-based drilling optimization system.

Unlike prior technologies, which reactively adjust drilling parameters, MSE 3.0 prevents inefficiencies before they occur, resulting in improved drilling performance, extended bit life, and significant cost savings. This integration of advanced computational techniques makes MSE 3.0 a breakthrough innovation in drilling performance optimization.

### SUMMARY OF THE DISCLOSURE

The present disclosure relates to a novel ternary graph-based drilling optimization system that integrates Cuttings Morphology Analysis, Drill Pipe Vibration Monitoring, and Modified Mechanical Specific Energy (MSE) calculations. Unlike conventional MSE models that rely on independent parameter analysis, MSE 3.0 utilizes machine learning-driven data fusion, allowing for predictive optimization rather than reactive adjustments. The system significantly enhances drilling efficiency, reduces tool failure, and optimizes energy consumption through several unexpected innovations.

Unlike conventional models, which rely heavily on expensive downhole sensors, MSE 3.0 uses a cost-effective surface-based approach while maintaining accuracy in MSE calculations. The system enables dynamic parameter adjustments through AI-driven feedback loops, optimizing Rate of Penetration (ROP) and reducing mechanical failures. The disclosed system enhances real-time decision-making by integrating AI-driven predictive drilling optimization, enabling automated parameter adjustments based on MSE acceleration trends, thereby reducing reliance on manual intervention.

In one aspect, embodiments of the present disclosure relate to systems and methods for a Modified Mechanical Specific Energy (MSE 3.0) optimization system. This innovative approach leverages real-time downhole data through an integrated ternary graph-based optimization model, incorporating Cuttings Morphology Analysis, Drill Pipe Vibration Analysis, and Optimum Rate of Penetration (ORP) Analysis. The system provides dynamic and adaptive calculations of Modified MSE values, allowing proactive, data-driven adjustments to drilling parameters.

Key advantages of the MSE 3.0 system include:

Predictive Inefficiency Detection Using Second-Order MSE Derivative: Unlike conventional models that react to inefficiencies after they occur, MSE 3.0 applies a second-order derivative analysis to detect the acceleration of MSE fluctuations, allowing for preemptive adjustments that prevent dysfunctions such as stick-slip, whirl, and excessive energy loss before they impact drilling performance.

Elimination of Downhole Sensors with AI-Driven Surface-Based MSE Estimation: Traditional drilling models assume that direct downhole measurements are required for accuracy. MSE 3.0 disproves this assumption by utilizing surface telemetry and AI-based parameter reconstruction, achieving equal or superior accuracy without relying on expensive, failure-prone downhole sensors.

Ternary Graph-Based Visualization for Multi-Variable Efficiency Optimization: Prior methods treated Cuttings Morphology, Pipe Vibration, and MSE as independent diagnostic tools. MSE 3.0 integrates them into a ternary graphical model, automatically correlating multiple drilling parameters to detect inefficiencies significantly faster than single-variable analysis.

AI-Driven High-Resolution Cuttings Morphology Analysis: Conventional cuttings analysis depends on manual visual inspections or sporadic sampling, leading to delays and human error. MSE 3.0 employs high-resolution AI-driven image processing to classify cuttings in real time, instantly assessing bit wear, formation response, and inefficiencies, leading to improved drilling decisions.

Vibration Monitoring Using Historical “Sweet Spot” Data: Prior systems only react to real-time vibration fluctuations, often too late to prevent mechanical failures. MSE 3.0 compares real-time vibration patterns to historical optimal drilling conditions, detecting deviations before they escalate into costly inefficiencies.

Machine Learning for Real-Time Drilling Parameter Adjustments: Traditional drilling operations require manual adjustments of Weight on Bit (WOB), Rotational Speed (RPM), and Torque on Bit (TOB) based on predefined rules. MSE 3.0 introduces a self-optimizing AI system that continuously adjusts drilling parameters in real time, ensuring optimal efficiency without human intervention.

Broad Applicability Beyond Hydrocarbon Drilling (Geothermal, CCS, Mining): Conventional MSE optimization methods are limited to oil & gas drilling. MSE 3.0 expands its applicability to geothermal energy extraction, carbon capture and storage (CCS), and mineral exploration, providing a cost-effective and predictive drilling optimization framework across multiple energy sectors.

Integration of Mud Rheology and Fluid Dynamics into MSE Analysis: Prior MSE models focus solely on mechanical drilling parameters, ignoring fluid mechanics. MSE 3.0 integrates mud viscosity, density, and fluid flow dynamics into drilling efficiency calculations, optimizing hole cleaning, bit cooling, and formation stability in real time.

The disclosed invention provides a data-driven, machine learning-enhanced drilling optimization system that enables predictive inefficiency detection, real-time parameter optimization, and reduced operational costs. By leveraging AI, second-order MSE analysis, and multi-variable integration, MSE 3.0 offers a transformative improvement over traditional drilling efficiency model.

Unlike prior drilling optimization methods, which have historically treated Cuttings Morphology, Pipe Vibration, and MSE as independent and isolated diagnostic tools, MSE 3.0 introduces a unified ternary graph-based model, allowing for real-time multi-variable correlation that was previously unattainable.

Referring to FIG. 1, Framework for Machine Learning-Driven Drilling Optimization Using MSE, Cuttings Morphology, and Pipe Vibration, illustrates the interaction between Cuttings Morphology, Pipe Vibration, and Modified Mechanical Specific Energy (MSE) parameters within a machine learning-driven optimization system. The ternary diagram at the center represents how these three key drilling metrics are dynamically analyzed and integrated using real-time data processing.

Referring to FIG. 2, the ternary graph-based model visually highlights drilling inefficiencies in real time. Shaded regions represent drilling inefficiency zones, where excessive Standard MSE (Top Region), high Pipe Vibration (Lower Left), and poor Cuttings Morphology (Lower Right) lead to reduced performance. The central region (lighter shade) represents optimized drilling conditions. The X-marks show real-time Modified MSE measurements trending toward optimal drilling efficiency.

This real time visual early detection mechanism enables operators to implement corrective measures before performance degradation occurs, a functionality absent in conventional single-variable drilling models.

Other aspects and advantages of the invention will be apparent from the following description and the appended claims.

### BRIEF DESCRIPTION OF DRAWINGS

FIG. 1. Framework for Machine Learning-Driven Drilling Optimization Using MSE, Cuttings Morphology, and Pipe Vibration.

FIG. 1 illustrates the interaction between Cuttings Morphology, Pipe Vibration, and Modified Mechanical Specific Energy (MSE) parameters within a machine learning-driven optimization system. The ternary diagram at the center represents how these three key drilling metrics are dynamically analyzed and integrated using real-time data processing.

FIG. 2 illustrates an Example Ternary Plot Indicating Predictive Inefficiency Detection.

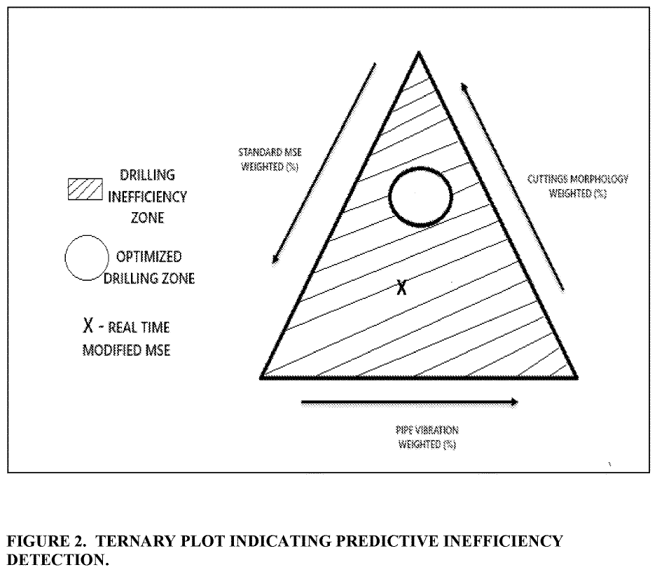

In FIG. 2, shaded regions represent drilling inefficiency zones, where excessive Standard MSE (Top Region), high Pipe Vibration (Lower Left), and poor Cuttings Morphology (Lower Right) lead to reduced performance. The central region (lighter shade) represents optimized drilling conditions. The X-marks show real-time Modified MSE measurements trending toward optimal drilling efficiency.

### DETAILED DESCRIPTION

The following detailed description provides a comprehensive explanation of the Modified Mechanical Specific Energy (MSE 3.0) system and methods using a ternary graph-based approach. This section ensures that a person skilled in the art can fully understand and reproduce the invention by detailing its components, algorithms, and industrial applicability.

The embodiments described herein illustrate how the system integrates real-time monitoring, predictive analytics, and optimization algorithms to enhance drilling efficiency, reduce operational costs, and improve wellbore stability.

### Overview of the System

MSE 3.0 is an advanced drilling optimization system that integrates three primary data sources—Cuttings Morphology Analysis, Drill Pipe Vibration Analysis, and Optimum Rate of Penetration (ORP) Analysis—to dynamically calculate and refine Modified Mechanical Specific Energy (MSE). The system utilizes a ternary graph-based optimization approach to visually and mathematically represent the interactions between these parameters, allowing for real-time adjustments to drilling operations.

The system addresses the shortcomings of traditional MSE analysis by incorporating real-time surface conditions, direct data from downhole analyzed from real time processing of drill cuttings, AI-driven predictive models, and second-order optimization techniques. Unlike conventional surface-controlled drilling efficiency models, MSE 3.0 continuously assesses direct measurements, including drill cuttings morphology and pipe vibration, making proactive adjustments based on predictive analytics rather than relying solely on reactive modifications after inefficiencies arise.

### Hardware Components

MSE 3.0 comprises several key hardware elements that facilitate real-time data collection and system integration:

High-Resolution Video Apparatus for Cuttings Morphology Analysis. Utilizes high-definition cameras installed at shale shakers to capture real-time images of cuttings. Employs AI-driven image processing algorithms to classify cuttings based on size, shape, and texture. Establishes a baseline morphology from historical drilling data to identify deviations and predict inefficiencies.

Drill Pipe Vibration Monitoring Sensors. Integrates acoustic and accelerometer-based sensors along the drill string to capture axial, torsional, and lateral vibrations. Provides real-time frequency and amplitude measurements to detect and mitigate harmful drilling dynamics such as stick-slip, whirl, and bit bounce. Compares real-time vibration data with historical baseline values to proactively adjust drilling parameters based on machine learning insights.

Surface-Based Data Acquisition System. Collects critical drilling parameters, including Weight on Bit (WOB), Torque (TOB), Rotational Speed (RPM), and Rate of Penetration (ROP). Transmits real-time data via a high-speed telemetry system to the surface processing unit for analysis and visualization, eliminating the need for costly downhole sensors.

### Software/Algorithmic Aspects

The MSE 3.0 system incorporates a series of data-driven computational models that enhance decision-making and system optimization:

Ternary Graph-Based Optimization Model. Represents the three core parameters (Cuttings Morphology, Pipe Vibration, and MSE) within a ternary coordinate system for real-time visualization. The weighted coefficients assigned to each of the three parameters (Cuttings Morphology, Pipe Vibration, and MSE) dynamically adjust in response to real-time changes in drilling conditions, ensuring that inefficiencies are highlighted before they impact operations. Dynamically updates real-time data to visualize optimal drilling regions and inefficient zones. Provides a clear and immediate representation of drilling interactions, allowing operators to refine operational parameters in real time.

Second-Order Optimization Model. The system computes the second derivative of Modified MSE (d²MSE/dt²) in real-time, identifying points where MSE acceleration exceeds predefined thresholds, triggering automated drilling parameter adjustments.”

The system implements second-derivative calculations of Modified MSE with respect to time to assess drilling trends. Predicts operational inefficiencies by analyzing whether MSE acceleration is increasing or decreasing. Enables preemptive drilling parameter adjustments by integrating AI-based pattern recognition.

Machine Learning-Based Predictive Analytics. Continuously refine operational recommendations using a self-learning AI framework. Leverages historical drilling performance data to improve real-time parameter recommendations. Provides automated alerts and real-time adjustments to mitigate potential inefficiencies before they impact performance.

### Enablement Requirements and Implementation Details

To ensure that a skilled person in the field can reproduce the invention, the following sections detail the hardware calibration, software implementation, and data sources used for machine learning training and optimization.

### Hardware Calibration

The MSE 3.0 system requires precise calibration of its hardware components to ensure accuracy in data collection and analysis. The calibration process includes:

High-Resolution Video Apparatus for Cuttings Analysis: Calibrated using known reference cuttings samples to ensure correct image recognition and classification.

Drill Pipe Vibration Sensors: Baseline frequency response measurements are conducted before deployment to distinguish drilling-induced vibrations from ambient noise.

Torque and Weight on Bit (WOB) Sensors: Factory-calibrated and verified on-site to maintain measurement accuracy within 1% deviation.

Telemetry System Calibration: Ensures that real-time data transmission from surface sensors remains synchronized with machine learning prediction models.

High-Resolution Video Apparatus for Cuttings Analysis: Calibrated using known reference cuttings samples to ensure correct image recognition and classification.

Drill Pipe Vibration Sensors: Baseline frequency response measurements are conducted before deployment to distinguish drilling-induced vibrations from ambient noise. Torque and Weight on Bit (WOB) Sensors:

Factory-calibrated and verified on-site to maintain measurement accuracy within 1% deviation. Telemetry System Calibration: Ensures that real-time data transmission from surface sensors remains synchronized with machine learning prediction models.

### Software Algorithms Used For Real-Time Tuning

The system incorporates multiple software layers to optimize drilling in real time:

Ternary Graph-Based Optimization Algorithm: Normalizes Cuttings Morphology, Pipe Vibration, and MSE data to ensure consistency. Real-time graphical updates allow for instant visualization of drilling efficiency zones.

Second-Derivative Optimization Model: Uses real-time drilling parameters to compute the acceleration of MSE fluctuations. Predicts inefficiencies before they escalate, triggering proactive system adjustments.

Machine learning algorithms continuously analyze inefficiency patterns in drilling data, dynamically modifying the weighting coefficients of Cuttings Morphology, Pipe Vibration, and MSE within the ternary graph-based optimization model to ensure real-time adaptive decision-making.

Neural Networks: Trained to detect subtle variations in drilling efficiency patterns. Reinforcement Learning: Continuously improves optimization strategies based on real-time feedback.

### Machine Learning Models and Training Process

The MSE 3.0 system leverages multiple machine learning models to enhance predictive accuracy and optimize drilling performance. These models include: Neural Networks (NNs): Used for pattern recognition in historical drilling data and real-time operational adjustments. Decision Trees (DTs): Applied for classification and quick decision-making in optimizing drilling parameters. Reinforcement Learning (RL): Enables adaptive learning based on feedback from real-time drilling performance.

The training dataset consists of: Historical Drilling Data: Collected from previous wellbores, including mechanical properties, MSE fluctuations, and operational parameters. Real-Time Sensor Data: Inputs from surface-based sensors, including Weight on Bit (WOB), Torque on Bit (TOB), and vibration analysis. Simulation Data: AI-driven modeling of expected drilling conditions, used to pre-train models before deployment in the field.

The ML models improve over time using self-learning techniques, including: Continuous Feedback Loops: ML algorithms refine decision-making based on deviations between predicted and actual performance. Adaptive Parameter Tuning: The model adjusts recommended drilling settings dynamically to maximize Rate of Penetration (ROP) while minimizing inefficiencies. Drift Detection Mechanisms: AI monitors sensor data patterns for anomalies that indicate changes in drilling conditions, ensuring model adaptability.

This implementation of AI-based self-learning optimization differentiates MSE 3.0 from traditional drilling models, making it uniquely capable of preemptively detecting inefficiencies and dynamically adjusting drilling parameters without human intervention.

The combination of precise hardware calibration, advanced software algorithms, and robust training datasets ensures that MSE 3.0 is fully enabled for real-world application, making it a self-adaptive, highly scalable drilling optimization system.

### Operational Workflow

The MSE 3.0 system follows a structured sequence of operations to ensure real-time monitoring, processing, and adjustment of drilling parameters:

Real-Time Data Collection. Sensors and cameras continuously capture downhole and surface drilling conditions. Data is transmitted to the surface processing unit using high-speed telemetry.

Data Processing and Analysis. AI-driven algorithms analyze cuttings morphology, vibration data, and drilling parameters. The ternary graph-based model dynamically updates to reflect current drilling conditions.

Predictive Optimization and Adjustment. The second-order optimization model forecasts potential inefficiencies based on data trends. Machine learning algorithms detect patterns and recommend optimized drilling parameters.

Real-Time Drilling Optimization. Adjustments are implemented in real time to maintain optimal drilling efficiency. The system continuously refines its predictive model based on newly acquired data.

### Use Cases & Applications

MSE 3.0 is designed to be applicable across multiple industries and drilling environments, including:

Hydrocarbon Drilling. Optimizes drilling performance in oil and gas wells by reducing energy consumption and improving bit longevity. Enhance operational safety by mitigating vibration-induced equipment failures.

Geothermal Well Construction. Improves wellbore stability in high-temperature environments by integrating ternary graph visualization with real-time AI adjustments. Reduces inefficiencies associated with geothermal drilling constraints.

Carbon Capture and Storage (CCS) Operations. Ensures efficient wellbore construction for CO2 injection and storage by maintaining optimal ROP values and reducing formation damage. Enhances reservoir integrity through predictive optimization of drilling dynamics.

Critical Mineral and Resource Extraction. Provides improved efficiency in mining operations requiring wellbore construction for mineral extraction. Reduces energy costs by dynamically adjusting drilling parameters based on AI-driven cuttings analysis.

### Advantages Over Existing Technologies

MSE 3.0 offers several advancements over traditional MSE-based drilling optimization methods:

Enhanced Real-Time Monitoring. Unlike conventional MSE calculations, which rely solely on surface data, MSE 3.0 integrates real-time downhole conditions. Provides immediate insights into drilling performance through AI-driven cuttings analysis and vibration monitoring.

Predictive Analytics for Proactive Optimization. Traditional models reactively adjust drilling parameters after inefficiencies have been detected. MSE 3.0 predicts inefficiencies before they occur, allowing for proactive drilling adjustments.

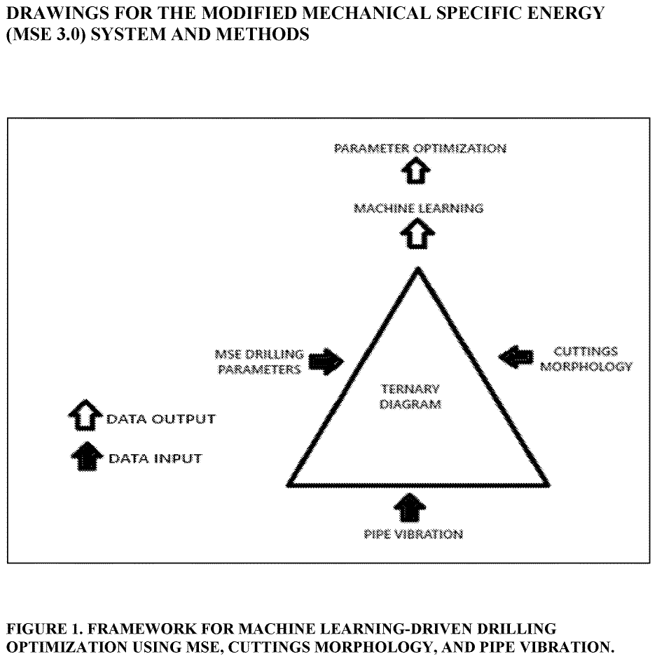

Ternary Graph-Based Visualization. Traditional drilling analysis relies on single-parameter optimization, often missing key interdependencies. MSE 3.0's ternary visualization, see FIG. 1, clearly illustrates the relationship between cuttings morphology, vibration, and MSE, enabling more effective decision-making.

Machine Learning Integration. Unlike traditional rule-based optimization, MSE 3.0 continuously improves its predictive capabilities using AI-based learning. Provides an adaptive optimization framework that evolves with each drilling operation.

Cost-Effective Surface-Based Measurement Approach. Conventional MSE measurement techniques often require the use of downhole sensors, including pressure, vibration, and strain gauges, which are costly to install and maintain due to harsh downhole conditions, high-temperature exposure, and frequent replacements.

The MSE 3.0 system uniquely achieves real-time optimization without requiring downhole instrumentation by leveraging surface-located sensors to collect critical drilling parameters such as Weight on Bit (WOB), Torque (TOB), Rotational Speed (RPM), and Cuttings Morphology Analysis.

By integrating advanced AI-based pattern recognition and machine learning algorithms, MSE 3.0 compensates for the lack of direct downhole measurements, enabling predictive modeling that mimics downhole conditions without requiring physical sensors in the borehole. This approach significantly reduces operational costs, improves reliability, and minimizes downtime caused by sensor failures, offering a cost-effective and scalable alternative to traditional downhole monitoring solutions

What is claimed:

1. A method for optimizing drilling efficiency using a ternary graph-based model, as illustrated in FIG. 1, wherein input variables include Cuttings Morphology, Pipe Vibration, and Modified MSE, dynamically weighted based on historical performance datasets and real-time telemetry, wherein:
a. A high-resolution imaging apparatus continuously captures cuttings morphology at the shale shaker and classifies them based on AI-driven image processing;
b. A set of accelerometer-based sensors and acoustic sensors detect drill pipe vibrations, capturing axial, torsional, and lateral instability data in real time;
c. A computational model calculates real-time Modified MSE by combining Weight on Bit (WOB), Torque (TOB), Rotational Speed (RPM), and Rate of Penetration (ROP), which is dynamically updated in the ternary visualization; and
d. A ternary graph-based algorithm maps these three input variables, applying weighted coefficients to visualize optimal drilling conditions and inefficiencies.

2. The method of claim 1, wherein the ternary graph-based visualization model dynamically adjusts the weighting of Cuttings Morphology, Pipe Vibration, and Modified MSE data, based on:
a. A feedback loop integrating real-time drilling conditions with historical ‘sweet spot’drilling data;
b. A machine learning-based optimizer that assigns dynamic weighting coefficients to each input based on detected inefficiencies; and
c. A color-coded visualization layer that indicates areas of instability, optimal drilling conditions, and real-time deviations from expected performance.

3. A predictive analytics system for drilling optimization, wherein:
a. A second-order derivative model continuously calculates the rate of change of Modified MSE over time to detect acceleration or deceleration of energy inefficiency;
b. A reinforcement learning algorithm dynamically refines the threshold levels for MSE acceleration based on real-time and historical drilling conditions; and
c. A real-time alert system provides predictive warnings when MSE acceleration exceeds an operational threshold, allowing for early intervention before efficiency loss occurs.

4. The system of claim 2, wherein an adaptive machine learning framework updates threshold values for Modified MSE optimization, comprising:
a. A decision tree-based classifier that determines optimal drilling parameters based on real-time cuttings morphology and vibration patterns;
b. A neural network model trained on historical drilling efficiency data, which continuously refines MSE threshold predictions.
